(19) United States
(12) Patent Application Publication
(10) Pub. No.: US 2024/0210358 A1
(43) Pub. Date: Jun. 27, 2024

(54) Method and Device for Checking the Wall of a Pipeline for Flaws

(71) Applicant: NDT Global Corporate Ltd., Dublin 9 (IE)

(72) Inventors: Magne Aanes, Nesttun (NO); Michael Haas, Linkenheim-Hochstetten (DE); Thomas Hennig, Walzbachtal (DE)

(21) Appl. No.: 18/558,152

(22) PCT Filed: May 4, 2022
(86) PCT No.: PCT/EP2022/061954

§ 371 Date: Oct. 30, 2023

(30) Foreign Application Priority Data
May 5, 2021 (EP) 21172337.4

(51) Int. Cl. G01N 29/04; G01N 29/34

(52) U.S. Cl. CPC G01N 29/041; G01N 29/043; G01N 29/343; G01N 2291/044; G01N 2291/2636

(57) ABSTRACT

The present disclosure relates to a method for detecting a defect (16) in a pipeline wall (14) and a pipeline inspection device for being inserted into a pipeline. The method comprises the steps of arranging a first ultrasonic transducer (10) inside a pipeline at a finite stand-off distance (d-i) from the pipeline wall (14); emitting, by the first ultrasonic transducer (10), a first ultrasonic signal towards the pipeline wall (14) at a finite angle (a) relative to a normal of the pipeline wall (14), wherein the first ultrasonic signal excites at least one fundamental Lamb mode in the pipeline wall (14); and receiving, by the first ultrasonic transducer (10), a second ultrasonic signal from the surface of the pipeline wall (14), wherein the second ultrasonic signal is an echo signal generated by the at least one fundamental Lamb mode excited by the first ultrasonic signal and reflected from a defect (16) in the pipeline wall (14).

### TECHNICAL FIELD

The present disclosure relates to a method and a device for checking an object, especially the wall of a gas-filled pipeline for flaws. In particular, the present disclosure may relate to a method for detecting a defect in a pipeline wall and a pipeline inspection device.

### BACKGROUND

Pipelines can be inspected non-destructively and in situ using so-called pigs carrying the inspection equipment including, e.g., piezoelectric ultrasonic transducers. The pressure-driven flow of the fluid in the pipeline to be inspected is used to push the pig along down the pipeline. As the pig travels through the pipeline, selected ones of the ultrasonic transducers pick up the inspection signals as a function of the distance covered. After or even during inspection, the inspection signals can be read and analysed.

Inspecting pipelines using ultrasound signals is well known. An ultrasound signal impinging on a pipeline wall may lead to the formation of standing and propagating elastic waves in the pipeline wall, including Rayleigh and Lamb waves. Lamb waves exhibit velocity dispersion, i.e., their velocity of propagation depends on the frequency (or wavelength) as well as on the elastic constants and density of the material. Lamb waves comprise symmetric and antisymmetric zero-order (S0, A0) and higher-order (S1, A1 and higher) modes, wherein the zero-order (fundamental) modes exist over the entire frequency spectrum from zero to indefinitely high frequencies. By contrast, each higher-order mode exists only above a certain characteristic frequency.

In known detection methods, detecting defects in the pipeline wall using Lamb waves is based on the use of exciting and propagating higher-order Lamb modes (i.e., S1, A1 and higher modes). Ultra-wide band ultrasonic transducers with an angle of incidence of 0° are typically used to excite these Lamb modes. As the sound field of these sensors has contributions with wave vectors with orientations that deviate from 0°, not only standing waves are generated, but also propagating Lamb waves just above their cut-off frequency. The Lamb waves are guided waves, and due to the symmetry of the transmitter sensor set-up, the wave front of the Lamb waves has circular symmetry. In a known set up, several receiving sensors are arranged around a central transmitter and receive the transmitted Lamb waves. The detection principle is the following: if there is a crack located in the path of a propagating Lamb wave, the transmitted Lamb wave amplitude drops. The receiving sensors record this drop in received Lamb wave amplitude. This set-up is described in WO 2016/137335 A1.

However, other defect types such as corrosion and laminations can cause a drop in transmitted signal amplitude too. In addition, a change in sensor lift-off, angle of incidence, and boundary conditions can cause signal drops in the same order of magnitude.

Achieving and maintaining a good signal-to-noise ratio during inspection is therefore a significant challenge and it is an object of the present invention to provide a method for detecting flaws in an object such as a pipeline wall with higher accuracy and improved signal-to-noise ratio.

### SUMMARY OF THE INVENTION

An aspect of the invention relates to a method for detecting a defect in a pipeline wall, comprising the steps of arranging a first ultrasonic transducer inside a pipeline at a finite stand-off distance from the pipeline wall; emitting, by the first ultrasonic transducer, a first ultrasonic signal towards the pipeline wall at a finite angle relative to a normal of the pipeline wall, wherein the first ultrasonic signal excites at least one fundamental Lamb mode in the pipeline wall; and receiving, by the first ultrasonic transducer, a second ultrasonic signal from the surface of the pipeline wall, wherein the second ultrasonic signal is an echo signal generated by the at least one fundamental Lamb mode excited by the first ultrasonic signal and reflected from a defect in the pipeline wall.

The present disclosure is based on the surprising insight that in the known approach of using transducers with 0° angle of incidence, only a very small part (if any) of the sound field with lower amplitude contributes to the generation of propagating Lamb modes resulting in a small signal-to-noise ratio in the detection of cracks (e.g. defects) using transmission signals. Using a finite (e.g., an oblique) angle of incidence (i.e., an angle>0°, for example in the range of 5° to 12°) the fundamental Lamb modes S0 and/or A0 can be excited using the central part of the sound field of the first ultrasonic signal which leads to a significant improvement in the signal-to-noise ratio, thereby extending the overall detection accuracy and the range of defects which are detectable using this method.

Moreover, choosing a finite angle may allow for exciting Lamb waves in the pipeline wall with a higher signal-to-noise ratio compared to the excitation using a vanishing angle of incidence. Exciting Lamb waves in a gas environment, for example in comparison to shear bulk waves, may allow for a more robust setup that is less prone to misalignment.

The pipeline may be based on a metal (e.g., may consist of a metal or a metal alloy, such as steel, except for impurities). The pipeline may be filled with a pressurized gas, e.g. at least one of hydrogen or a natural gas. That is to say, it may be possible that the method can be performed in a (pressurized) gas environment. In a gas environment, obtaining a signal from the Lamb waves with a sufficiently high signal-to-noise ratio can be challenging. This may be caused by an acoustic impedance mismatch between the (pressurized) gas and the material of the pipeline, which makes it difficult to couple the ultrasonic signal into the material of the pipeline. Due to this reduced coupling, the signal-to-noise ratio may be reduced compared to a pipeline that is filled with a material with a reduced acoustic impedance mismatch (e.g., a liquid). Alternatively, or in addition, the coupling efficiency may strongly depend on the angle of incidence, thereby making the system less robust to angle deviations. In contrast, the impedance mismatch in a liquid environment may be less pronounced. In a liquid environment, the coupling efficiency therefore may be higher compared to a gas environment and/or the coupling efficiency might be less prone to angle deviations. The first ultrasonic transducer (and/or other ultrasonic transducers that might be used, e.g. a second, third and/or fourth ultrasonic transducer) may be a gas-coupled transducer.

The finite angle may be in a range of 5° to 12° (e.g., in a range of 7° to 10°). The finite angle may be enclosed by a surface normal of the pipeline wall and the direction of propagation of the first ultrasonic signal. A plane of incidence may run along and/or parallel to the surface normal and a propagation direction of the generated Lamb waves may lie in the plane of incidence. In general, here and in the following, an angle between an ultrasonic signal and the normal of the pipeline wall is typically measured between the direction of propagation of said ultrasonic signal and a surface normal of the pipeline wall, e.g. the normal of the pipeline wall at the location where the ultrasonic signal impinges on the pipeline wall or a surface normal parallel to said normal. For example, the pipeline wall may comprise several surface normals. All surface normals may run parallel to another or all surface normals may run oblique to another or at least some of the surface normal may run parallel and the other surface normal may run oblique to another. In general, the angle of incidence of an ultrasonic signal emitted by an ultrasonic transducer may be measured between the surface normal at the position of impact of the ultrasonic signal onto the pipeline wall and the ultrasonic signal emitted by the ultrasonic transducer, in particular the main propagation axis of the ultrasonic signal. Such an angle may therefore be an angle of incidence. In comparison, an angle of incidence in a liquid or solid environment may be larger than 20°.

The stand-off distance, in general, may be measured along the direction of the normal of the pipeline wall. The stand-off distance may be in the range of at least 6 cm and at most 20 cm (e.g., at most 12 cm). The first ultrasonic signal can be an ultrasonic pulse of length Δt₁ in the time-domain having a single frequency f₁. Here, the first ultrasonic signal may be a single pulse or may comprise a repetition of several ultrasonic pulses. Preferably, both the length Δt₁ and the frequency f₁ are independently tuneable and adjustable. For example, the first ultrasonic signal may be a so-called tone burst. A tone burst is an ultrasonic sine pulse with a finite length in the time-domain with a single frequency. The repetition rate of the ultrasonic pulse of the first ultrasonic signal may be chosen according to the signal processing capabilities of the used electronics. A higher repetition rate may enable to perform the method in a faster manner, e.g. to move the pipeline inspection device faster through the pipeline. For example, the repetition rate of the ultrasonic pulse of the first ultrasonic signal may be at most 500 Hz (e.g. at most 400 Hz or at most 300 Hz or at most 200 Hz). It may be possible that the repetition rate is at least 80 Hz. The pulse length of the ultrasonic pulse of the first ultrasonic signal may be in the range of at least 1 μs and at most 30 μs.

Throughout this application, each ultrasonic signal emitted by an ultrasonic transducer may be a tone burst as described before.

The advantage of a tone burst is based on the additional surprising insight that known crack detection methods use ultrasound pulses created by linear chirp excitation (also called: frequency sweep) to cover a frequency band wide enough to excite more than one Lamb mode and/or to cover a range of pipeline wall thicknesses. The received signal is therefore very long in the time domain and does not allow for a pulse-echo based crack detection. Moving away from the broad banded linear chirp excitation towards a single-frequency pulse of well-defined length in the time domain addresses and overcomes this issue. In addition, using a single frequency makes it possible to highly selectively excite propagating waves (esp. in the form of fundamental Lamb modes) in the pipeline wall. Moreover, if an angle of incidence of 0° is used, a linear chirp excitation may excite a standing wave locally beneath the ultrasonic transducer; such a standing wave could mask an ultrasonic signal that has propagated in the pipeline wall in the direction of the ultrasonic transducer (e.g., after reflection at a defect and/or propagation via a defect).

The method may, in some embodiments, comprise arranging several ultrasonic transducers in the pipeline, each at a respective finite stand-off distance from the pipeline wall. Each of the several ultrasonic transducers may emit a respective ultrasonic signal at a respective finite angle relative to a normal of the pipeline wall. It may be possible that at least some of the ultrasonic signals are emitted at the same time. Separately or in combination, there may be a time delay between different ultrasonic signals, e.g. to avoid overlap of the different ultrasonic signals. The finite angle may be different for each of the transducers. However, it may also be possible that at least some of the transducers emit an ultrasonic signal with the same angle relative to the surface normal of the pipeline wall. It may also be possible that some of the transducers emit an ultrasonic signal at the same absolute angle, but with a different direction. The ultrasonic signal of at least some of the ultrasonic transducers, preferable of each of the ultrasonic transducers, may each excite at least one fundamental Lamb mode in the pipeline wall. The method may further comprise receiving, by the ultrasonic transducers, a reflected ultrasonic signal that is an echo signal generated by the at least one fundamental Lamb mode excited by the ultrasonic signals and reflected from a defect in the pipeline wall. Here, it may be possible that each ultrasonic transducer receives only the reflected ultrasonic signal corresponding to the ultrasonic signal emitted by the ultrasonic transducer. However, typically, the ultrasonic transducers will also receive at least part of the reflected ultrasonic signal corresponding to the ultrasonic signal emitted by a different ultrasonic transducer.

A further aspect of the disclosure relates to a method for detecting a defect in a pipeline wall, comprising the steps of arranging a first ultrasonic transducer and a second ultrasonic transducer inside a pipeline, each at a finite stand-off distance from the pipeline wall, wherein the first and second transducers are arranged at a second distance from each other; emitting, by the first ultrasonic transducer, a first ultrasonic signal towards the pipeline wall at a finite angle relative to the normal of the pipeline wall, wherein the first ultrasonic signal excites at least one fundamental Lamb mode in the pipeline wall; and receiving, by the second ultrasonic transducer, a third ultrasonic signal from the surface of the pipeline wall, wherein the third ultrasonic signal is generated by the at least one fundamental Lamb mode excited by the first ultrasonic signal and having propagated within the pipeline wall over a third, finite distance d₃. This further aspect of the disclosure may refer to a so-called pulse-catch method (sometimes also referred to as pitch-catch).

The second distance may be measured in a plane defined by the normal of the pipeline wall, e.g. the normal of the pipeline wall at the position where the third ultrasonic signal exits the pipeline wall or where a fourth ultrasonic signal emitted by the second ultrasonic transducer would impinge on the pipeline wall. The normal of the pipeline wall along which the second distance is measured may be equal to or different to the normal of the pipeline wall along which the first distance is measured. The second distance and the first distance may have equal absolute values. The first ultrasonic signal may be a tone burst, in particular as described before.

The second ultrasonic transducer may be arranged such that if the second ultrasonic transducer emits an ultrasonic signal (e.g., a fourth ultrasonic signal) in the direction of the pipeline wall, an angle of incidence of said ultrasonic signal may be a negative finite angle relative to a normal of the pipeline wall. The negative finite angle may have the same absolute value as the finite angle but the reverse direction. For example, the first ultrasonic transducer and the second ultrasonic transducer may be arranged symmetrically with respect to a symmetry plane that runs along a normal of the pipeline wall.

The step of receiving, by the first ultrasonic transducer, the second ultrasonic signal may be carried out as an alternative step or in addition to the step of receiving, by the second ultrasonic transducer, the third ultrasonic signal from the surface of the pipeline wall. If the step of receiving, by the first ultrasonic transducer, the second ultrasonic signal is carried out as an alternative step to the step of receiving, by the second ultrasonic transducer, the third ultrasonic signal, the second ultrasonic transducer may, in the most basic set-up, be dispensed with, i.e., a set-up in which the first ultrasonic transducer is used to both emit and receive an ultrasonic signal at a finite angle so as to excite a fundamental Lamb wave in the pipeline wall and receive a corresponding echo signal.

The first ultrasonic transducer and the second ultrasonic transducer may be used in combination in a so-called pulse-catch or pitch-catch scheme and/or at least one or both of the first and the second ultrasonic transducer may be used individually in a so-called pulse-echo scheme. In both schemes, an ultrasonic signal is emitted by an ultrasonic transducer onto a pipeline wall and a Lamb mode may be excited in the pipeline wall by at least a part of the ultrasonic signal. The Lamb mode may propagate in the pipeline wall. At least a part of the excited Lamb wave may interact with a defect in the pipeline wall and may be reflected by and/or transmitted through the defect. In the case of a reflection, the reflected part of the ultrasonic signal may be received and measured by the same ultrasonic transducer that emitted the original ultrasonic signal (e.g., the first ultrasonic transducer; so-called pulse-echo scheme). In the case of a transmission, the transmitted part of the ultrasonic signal may be received and measured by a different ultrasonic transducer (e.g., the second ultrasonic transducer; so-called pitch-catch scheme). The pulse-echo scheme and the pitch-catch scheme may be combined or may be used separately.

In the case of a pitch-catch scheme, if no defect is present in the pipeline wall, the Lamb wave may travel through the pipeline wall without interruptions and second ultrasonic transducer typically measures a higher ultrasonic signal (background signal) compared to the presence of a defect. The background signal may vary over time. The pitch-catch scheme therefore typically results in a drop of the ultrasonic signal received by the second ultrasonic transducer in case of a defect. In contrast, for the pulse-echo scheme, if no defect is present in the pipeline wall, the Lamb wave will not be reflected from the defect and the reflection signal at the first ultrasonic transducer will be in the range of the general noise level. The background signal for the pulse-echo scheme therefore may be lower than for the pitch-catch scheme, which may allow for a higher signal-to-noise ratio for the pulse-echo scheme.

The method may further comprise the steps of emitting, by the second ultrasonic transducer, a fourth ultrasonic signal towards the pipeline wall at a negative finite angle relative to the normal of the pipeline wall, wherein the fourth ultrasonic signal excites at least one fundamental Lamb mode in the pipeline wall. The negative finite angle may have the same absolute value as the finite angle but the reverse direction. The negative finite angle may be measured with respect to a normal of the pipeline wall that is the same or different to the normal of the pipeline wall in the case of the finite angle described in connection with the first ultrasonic signal.

The method may further comprise at least one of: (i) receiving, by the first ultrasonic transducer, a fifth ultrasonic signal from the surface of the pipeline wall, wherein the fifth ultrasonic signal is generated by the at least one fundamental Lamb mode excited by the fourth ultrasonic signal and having propagated within the pipeline wall over the finite third distance; or (ii) receiving, by the second ultrasonic transducer, a sixth ultrasonic signal from the surface of the pipeline wall, wherein the sixth ultrasonic signal is an echo signal generated by the at least one fundamental Lamb mode excited by the fourth ultrasonic signal and reflected from a defect in the pipeline wall.

Preferably, the fourth ultrasonic signal is an ultrasonic pulse of length Δt₄ in the time-domain having a single frequency f₄. The fourth ultrasonic signal may therefore also be a tone burst. In a further preferred embodiment, both the length Δt₄ and the frequency f₄ are independently tuneable and adjustable. As pointed out before, the well-defined length of the pulse in the time-domain makes it possible or at least easier to interpret the received transmitted/reflected signals. In addition, using a pulse having a precisely defined frequency makes it possible to excite specific modes and resonances within the pipeline wall.

In a particularly preferred embodiment, the first ultrasonic signal and the fourth ultrasonic signal are not emitted concurrently, but at an adjustable interval between the first ultrasonic signal and the fourth ultrasonic signal so as to allow for a clear separation and distinction of the various response signals in the time domain.

In a particularly preferred embodiment, the third distance is d₁−2*d₂*tan(α), wherein d₁ is the stand-off distance, d₂ is the second distance and a is the finite angle. This relation is true for an approximately planar pipeline wall. However, in the case of a curved pipeline wall, the relation may also be true, at least approximately.

In another preferred embodiment, the method comprises the step of arranging a third ultrasonic transducer inside the pipeline, wherein the third ultrasonic transducer emits a further ultrasonic signal (preferably in the form of a single-frequency pulse of a defined length in the time domain, e.g. as a so-called tone burst) at a second, different finite angle relative to a normal of the pipeline wall configured to excite at least one fundamental Lamb mode in the pipeline wall. In this context, “different” may mean that the second finite angle may be different than the finite angle at which the first ultrasonic signal is emitted. The second finite angle may be different to the finite angle, but may be in the same range (e.g. 5° to 12°). In this scenario, the first ultrasonic transducer and/or, if applicable, the second ultrasonic transducer may detect response signals originating from the pipeline wall. Alternatively, or in addition thereto, the third ultrasonic transducer may receive a further ultrasonic signal at a second, different finite angle relative to a normal of the pipeline wall originating, e.g., from the first ultrasonic signal and the fundamental Lamb wave it creates in the pipeline wall.

For example, the method may comprise emitting, by the third ultrasonic transducer, a further ultrasonic signal at the second, finite angle, wherein the emitted further ultrasonic signal excites at least one fundamental Lamb mode in the pipeline wall and receiving, with the first ultrasonic transducer and/or if applicable (i.e., if present) the second ultrasonic transducer, a response ultrasonic signal from the surface of the pipeline wall, wherein the response ultrasonic signal is generated by the at least one fundamental Lamb mode excited by the further ultrasonic signal and having propagated within the pipeline wall over a finite distance.

In yet another preferred embodiment, the method further comprises the steps of arranging a third ultrasonic transducer and/or a fourth ultrasonic transducer inside the pipeline, each at a finite further stand-off distance from the pipeline wall, wherein, preferably, the third and fourth transducers are arranged at a finite fifth distance from each other; emitting, by the third ultrasonic transducer, a seventh ultrasonic signal towards the pipeline wall at a different finite angle (i.e., different from the angle at which the first ultrasonic signal is emitted) relative to a normal of the pipeline wall, wherein the further (or seventh) ultrasonic signal excites at least one fundamental Lamb mode in the pipeline wall; and receiving, by at least one of the ultrasonic transducers and preferably the fourth ultrasonic transducer, an eighth ultrasonic signal from the surface of the pipeline wall, wherein the eighth ultrasonic signal is generated by the at least one fundamental Lamb mode excited by the seventh ultrasonic signal and having propagated within the pipeline wall over a finite sixth distance or by the at least one fundamental Lamb mode excited by the first ultrasonic signal. The seventh ultrasonic signal may correspond to the further ultrasonic signal discussed above. In this embodiment, the first and/or second transducers may additionally receive a respective ultrasonic signal generated by the at least one fundamental Lamb mode excited by the seventh ultrasonic signal.

The sixth distance can preferably be calculated as d₄−2*d₅*tan(α₂), d₄ being the further stand-off distance, d₅ being the fifth distance and α₂ being the second finite angle. Preferably, the seventh ultrasonic signal is an ultrasonic pulse of adjustable length Δt₇ in the time-domain having an adjustable single frequency f₇ (e.g., a tone burst).

According to at least one embodiment, the ultrasonic signal received by the first ultrasonic transducer (e.g. the second ultrasonic signal and/or the fifth ultrasonic signal and/or the response ultrasonic signal) is further processed with a signal processing unit. The ultrasonic signal received by any of the optionally present further ultrasonic transducers (e.g., the second, third and/or fourth ultrasonic transducer) may also be further processed with a signal processing unit, either the signal processing unit used for the ultrasonic signal received by the first ultrasonic transducer or at least one separate signal processing unit.

In some embodiments, the at least one signal processing unit may convert the ultrasonic signal into a storable data format, e.g. into digital bits. The data may then be stored in a memory device as stored data. It may be possible that no further signal processing is performed and only the signal conversion is performed while the ultrasonic signal is measured by the ultrasonic transducer and/or the optionally present further ultrasonic transducers. The memory device may then be evaluated in a later method step, which may be performed outside of the pipeline wall and/or while there is no signal measured by the ultrasonic transducer.

It may be possible that signal processing unit and/or the signal processing units decide, depending on the received ultrasonic signal and/or the stored data, whether or not a defect is present in the pipeline wall. It may also be possible that a further signal processing unit decides whether or not a defect is present, depending on the received ultrasonic signal and/or the stored data.

Due to the choice of an angle of incidence (e.g., corresponding to the finite angle, the negative finite angle, and/or the second finite angle) above 0°, it may be possible to have a sufficiently high signal by the excited Lamb mode that signal averaging may not be required in the signal processing unit. Averaging would require performing several measurements at the same spatial location, which could reduce the speed of the measurement significantly.

A further aspect of the present disclosure relates to a device/pig for inspecting a pipeline wall comprising first and second ultrasonic transducers and, optionally, third and/or fourth ultrasonic transducers being configured to conduct the steps of the method according to the first aspect. To this end, the device may comprise a processor and a memory comprising instructions which, when executed by the processor, control the device to carry out the method steps according to the first aspect.

In some examples, a pipeline inspection device may comprise a first ultrasonic transducer and a second ultrasonic transducer, a signal controller being operatively coupled with the ultrasonic transducers and configured to control each transducer to emit ultrasonic signals and configured to receive signals from each transducer which correspond to ultrasonic signals received by the respective transducer. The pipeline inspection device may be adapted to carry out the method, e.g. embodiments of the method, as described above.

According to at least some aspects, a pipeline inspection device for being inserted into a pipeline may be provided. The pipeline may have a pre-known fixed diameter. The pipeline inspection device may comprise a first ultrasonic transducer, a signal controller being operatively coupled with the first ultrasonic transducer and configured to control the first ultrasonic transducer to emit a first ultrasonic signal, and a support structure comprising a mounting means and at least one spacer. The first ultrasonic transducer may be mounted to the mounting means such that, in operation of the pipeline inspection device, the first ultrasonic signal encloses a finite angle with the normal of the pipeline wall. Further, the mounting means and the at least one spacer may be arranged and/or adjusted such that, in operation of the pipeline inspection device, the first ultrasonic transducer has a pre-determined finite stand-off distance to a pipeline wall of the pipeline. The term “mounting means being arranged and/or adjusted” may also include that the first ultrasonic transducer is mounted to the mounting means such that the finite stand-off distance is achieved. The pipeline wall may be an inner pipeline wall of the pipeline.

Here, “in operation of the pipeline inspection device” may refer to the case of the pipeline inspection device being inserted into a pipeline. The operation does not require the pipeline inspection device to be turned off, but it can also comprise this on-state of the pipeline inspection device. The pipeline inspection device may be configured for being inserted into a pipeline with a pre-known diameter. A person skilled in the art usually may be capable of determining the intended pipeline diameter from examining the pipeline inspection device. The position of the first ultrasonic transducer at the mounting means, the dimensions of the at least one spacer and the angle of an output of the first ultrasonic transducer may be directly linked to the method being performed with the pipeline inspection device.

The signal controller may comprise electronics for controlling the first ultrasonic transducer and/or the optionally further ultrasonic transducers. For example, the signal controller may control the first ultrasonic transducer to emit the first ultrasonic signal. The signal controller may additionally control the first ultrasonic transducer to receive an ultrasonic signal (e.g. the second ultrasonic signal and/or the fifth ultrasonic signal and/or the response ultrasonic signal). It may alternatively be possible that the pipeline inspection device comprises a further signal controller that controls the first ultrasonic transducer to receive an ultrasonic signal. The signal controller may comprise or may be coupled to the signal processing unit. For example, the received ultrasonic signal may be further processed by the signal processing unit.

The pipeline inspection device may be capable of performing the method as described herein. All features disclosed in connection with the method may therefore also be disclosed in connection with the pipeline inspection device and vice versa. For example, the pipeline inspection device may further comprise at least one of a second ultrasonic transducer, a third ultrasonic transducer or a fourth ultrasonic transducer, the second/third/fourth ultrasonic transducer being adjusted and/or arranged for being used in embodiments of a method as described above. This may include the second/third/fourth ultrasonic transducer being mounted to the mounting means similar to the first ultrasonic transducer in order to achieve the required angle of incidence (e.g., the negative finite angle or the second finite angle) as described above and/or the stand-off-distance and/or further stand-off distance as described above.

The pipeline inspection device may comprise only a single spacer or multiple spacers. The at least one spacer may be formed separately from the mounting means, may be connected to the mounting means and/or may even be formed in one piece with the mounting means. For example, the spacer may have a ring shape and/or a cylindrical shape. The spacer may comprise or may consist of several arms that are connected to the mounting means. The spacer may be rigid or may have some flexibility to allow for compensation of minor deviations in the diameter of the pipeline wall.

In some embodiments, at least part of the pipeline inspection device (e.g. the mounting means and/or the at least one spacer) may have a cylindrical shape (e.g. similar to a barrel). For example, the first (and/or further) ultrasonic transducer may be positioned at an outer surface of a cylindrical mounting means. Each of the top and bottom face of the mounting means may be connected to a spacer with a larger outer diameter than the mounting means.

The pipeline inspection device may comprise transport means, e.g. wheels. Using these transport means, the pipeline inspection device may be capable of traveling through the pipeline, e.g. with an inspection speed of between at least 0.5 m/s and at most 4 m/s (e.g., between at least 1 m/s and at most 2 m/s). A higher inspection speed may allow for a faster defect detection and to less downtime and/or disruptions of the pipeline operation.

In operation of the pipeline inspection device, the first ultrasonic transducer may emit a first ultrasonic signal (e.g., triggered by a control signal from the signal controller). The first ultrasonic signal may be a tone burst as described above. The first ultrasonic transducer may be adapted to emit the first ultrasonic signal to a gas environment (so-called gas-coupled transducer). The features of the first ultrasonic transducer described before may also apply to the optional second/third/fourth ultrasonic transducer.

According to at least some examples, the first ultrasonic transducer is configured to receive a second ultrasonic signal. If the pipeline inspection device comprises several ultrasonic transducer, each ultrasonic transducer or at least some of the ultrasonic transducers may be configured to receive an ultrasonic signal, e.g. as described above in connection with the method.

According to at least some examples, the finite angle, the stand-off distance and the first ultrasonic signal are chosen such that, in operation of the pipeline inspection device, at least one fundamental Lamb mode is excited in the pipeline wall by the first ultrasonic signal. For example, the finite angle may be chosen in a specific range and/or the radiation power of the first ultrasonic signal may be adjusted to the stand-off distance to allow for an excitation of the at least one fundamental Lamb mode.

According to at least some examples, the pipeline inspection device further comprises a second ultrasonic transducer. The second ultrasonic transducer may be configured to receive a third ultrasonic signal. The first ultrasonic transducer and the second ultrasonic transducer may be arranged such that, in operation of the pipeline inspection device, the first ultrasonic transducer and the second ultrasonic transducer are arranged at a second distance from each other. The mounting means and the at least one spacer may be arranged and/or adjusted such that, in operation of the pipeline inspection device, the second ultrasonic transducer has the pre-determined finite stand-off distance to the pipeline wall of the pipeline.

According to at least some examples, the signal controller is further coupled with the second ultrasonic transducer and configured to control the second ultrasonic transducer to emit a fourth ultrasonic signal. The second ultrasonic transducer may be mounted to the mounting means such that, in operation of the pipeline inspection device, the fourth ultrasonic signal encloses a negative finite angle with the normal of the pipeline wall, the negative finite angle having the same absolute value as the finite angle but the reverse direction.

In some examples, the pipeline inspection device comprises a third ultrasonic transducer and/or a fourth ultrasonic transducer being operatively coupled with the signal controller, wherein the signal controller is configured to control each ultrasonic transducer to emit and/or receive ultrasonic signals.

In at least some examples, the pipeline inspection device may be adapted to carry out the method as described above.

In at least some embodiments, the pipeline inspection device (e.g., the signal controller of the pipeline inspection device) may comprise a signal processing unit. The signal processing unit may be operatively coupled to the first ultrasonic transducer. If a second, third and/or fourth ultrasonic transducer are comprised by the inspection device, each ultrasonic transducer may be coupled to an individual signal processing unit or at least some, or even all, of the ultrasonic transducers may be coupled to a common signal processing unit. The pipeline inspection device therefore may comprise several signal processing units or only a single common signal processing unit. In the case of several signal processing units, a main processing unit (e.g., the processor) may be present in the inspection device and may be adapted to coordinate the individual signal processing units.

The signal processing unit may be adapted to further process the ultrasonic signal from the first ultrasonic transducer. For example, in a method described herein, the ultrasonic signal received by the first ultrasonic transducer (e.g., the first ultrasonic signal) may be further processed with the signal processing unit. If a second, third and/or fourth ultrasonic transducer are used, the ultrasonic signal measured with said ultrasonic transducer (e.g., the third, fifth, sixth, and/or eighth ultrasonic signal), may also be further processed with a signal processing unit. Each ultrasonic transducer may be coupled to an individual signal processing unit or at least some, or even all, of the ultrasonic transducers may be coupled to a common signal processing unit.

The at least one signal processing unit may process the received ultrasonic signal and, depending on the received ultrasonic signal, may decide whether or not a defect is present in the pipeline wall. For this, the signal processing unit may comprise a decision unit. In the case of a defect, the signal processing unit may determine and/or record the location, dimension (e.g., size), nature (e.g. type) and/or orientation of the defect. Separately or in combination, it may be possible to determine whether only a single defect or multiple defects are present.

For example, in operation, the ultrasonic signal (or the ultrasonic signals) may be processed (e.g., measured and further processed with the signal processing unit) continuously or at discrete points in time (e.g. intermittent).

The pipeline inspection device may further comprise a power source (e.g. a battery) to provide power to the ultrasonic transducer(s), the signal controller, the signal processing unit as well as other components (if required).

### BRIEF DESCRIPTION OF THE FIGURES

Exemplary embodiments of the present disclosure are described below with the help of the following figures:

FIG. 1 shows an embodiment of the method, where a first ultrasonic transducer is arranged in a pipeline.

FIG. 2 shows an embodiment of the method comprising a first ultrasonic transducer and a second ultrasonic transducer arranged in a pipeline;

FIG. 3 shows another embodiment of the method comprising two pairs of ultrasonic transducers arranged in a pipeline.

FIG. 4 shows an embodiment of a pipeline inspection device.

FIG. 5 shows an embodiment of a signal derived with a method according to embodiments of the present disclosure.

FIG. 6 shows an embodiment of a signal derived with a method according to embodiments of the present disclosure in comparison to an alternative signal.

FIG. 7 shows a relationship between an angle of incidence and an intromission angle for different materials.

### DETAILED DESCRIPTION

Embodiments of the disclosure are described below with reference to the Figures.

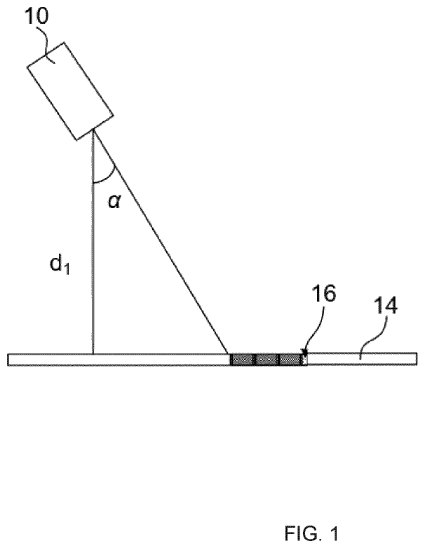

FIG. 1 shows a first embodiment of the present invention. In this embodiment, a first ultrasonic transducer 10 is arranged in a pipeline with a pipeline wall 14. The first ultrasonic transducer 10 may form part of an inspection device such as a so-called pig comprising a signal controller. The pipeline wall comprises a defect 16. The pipeline wall 14 may consist of a metal or a metal alloy and may have a nominally circular cross-section as well as a nominally constant wall thickness. It is worth noting that the present invention is not limited to any particular material or any particular cross-section/wall thickness of the pipeline to be inspected.

In the embodiment shown in FIG. 1, the first ultrasonic transducer 10 is arranged at a finite (first) stand-off distance d₁ from the pipeline wall 14 in the direction of a normal of the pipeline wall 14 (i.e., in a radial direction in this particular embodiment). The stand-off distance is preferably defined by the distance between the pipeline wall 14 and the centre of the surface of the first ultrasonic transducer 10, as shown in FIG. 1.

In order to detect the presence of the defect 16 and glean further information about it, the first ultrasonic transducer 10 emits a first ultrasonic signal, e.g. in the form of a so-called tone burst. The first ultrasonic signal is emitted by the first ultrasonic transducer 10 at an angle α relative to the normal of the pipeline wall 14 and then propagates through the gas medium in the pipeline (which can, for instance, be natural gas, hydrogen, air or a mixture thereof) until it is incident on the pipeline wall 14 at an angle of incidence of a, thereby exciting at least one fundamental Lamb mode S0, A0 within the pipeline wall 14 by means of the central part of the sound field making up the first ultrasonic signal. In other words, most of the energy inherent in the first ultrasonic signal is used to excite the fundamental Lamb mode(s). The angle α and the frequency of the first ultrasonic signal can be chosen and adjusted to excite (a) particular fundamental Lamb mode(s). The Lamb mode travels a certain distance within the pipeline wall 14, is reflected by the defect 16, thereby creating an echo signal that travels back into the direction of the entry point of the first ultrasonic signal. The reflected signal is coupled out of the pipeline wall 14 into the surrounding environment and propagated back to the first ultrasonic transducer 10. The first ultrasonic transducer 10 receives at least part of said reflected ultrasonic signal as a second ultrasonic signal. The second ultrasonic signal is then further processed to detect the presence of the defect 16.

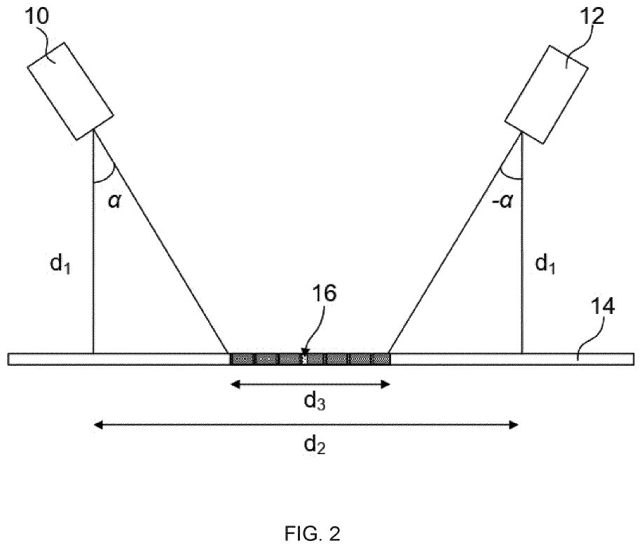

FIG. 2 shows a second embodiment of the present invention comprising a first ultrasonic transducer 10 and a second ultrasonic transducer 12 arranged inside a gas-filled pipeline and being surrounded by a pipeline wall 14 consisting of metal and having a nominally circular cross-section as well as a nominally constant wall thickness. It is worth noting that the present invention is not limited to any particular material or any particular cross-section/wall thickness of the pipeline to be inspected.

As shown in FIG. 2, the first ultrasonic transducer 10 and the second ultrasonic transducer 12 are each arranged at a finite (first) stand-off distance d₁ from the pipeline wall 14 in the direction of a normal of the pipeline wall 14 (i.e., in a radial direction in this particular embodiment). In addition, the first and second transducers 10, 12 are arranged at a second distance d₂ from each other in a plane defined by the normal of the pipeline wall. The stand-off distance is preferably defined by the distance between the pipeline wall 14 and the centre of the surface of each piezoelectric transducer creating the ultrasonic signal, as shown in FIG. 2. The second distance is preferably defined by the distance between the centre of the surface of the first transducer 10 creating/receiving ultrasonic signals and the centre of the surface of the second transducer 12 creating/receiving ultrasonic signals, as is also shown in FIG. 2.

The first and second ultrasonic transducers 10, 12 may form part of an inspection device (not shown) such as a so-called pig comprising a signal controller (not shown) comprising a memory and a processor, wherein the signal controller is operatively coupled with the transducers 10, 12 and configured to control each transducer 10, 12 to emit ultrasonic signals as well as to receive from each transducer 10, 12 signals which correspond to received ultrasonic signals. The inspection device further comprises a power source (not shown) to provide power to the ultrasonic transducers 10, 12, the signal controller as well as other components.

As indicated in FIG. 2, the pipeline wall 14 has a defect 16 in the form of a crack. To detect the presence of this defect 16 and glean further information about it, the first ultrasonic transducer 10 is configured to emit a first ultrasonic signal in the form of an ultrasonic pulse of a controllable length Δt₁ in the time-domain having a single adjustable frequency f₁. The pulse may be a single pulse or may be repeated at predetermined or variable intervals.

The first ultrasonic signal is emitted by the first ultrasonic transducer 10 at an angle α relative to the normal of the pipeline wall 14 and then propagates through the gas medium in the pipeline (which can, for instance, be natural gas, hydrogen, air or a mixture thereof) until it is incident on the pipeline wall 14 at an angle of incidence of a, thereby exciting at least one fundamental Lamb mode S0, A0 within the pipeline wall 14 by means of the central part of the sound field making up the first ultrasonic signal. In other words, most of the energy inherent in the first ultrasonic signal is used to excite the fundamental Lamb mode(s). The angle α and the frequency f₁ can be chosen and adjusted to excite (a) particular fundamental Lamb mode(s).

Having travelled a third distance d₃ within the pipeline wall 14, the Lamb mode excited by the first ultrasonic signal re-emerges from the pipeline wall 14 as a third ultrasonic signal at a negative angle of −α relative to the normal of the pipeline wall, thus spanning an angle of 2α between the incident (first) ultrasonic signal and the outgoing third ultrasonic signal.

The third distance d₃ depends on the first and second distances d₁, d₂ as well as the angle α and can be calculated as d₃=d₁−2*d₂*tan(α). This relation may be only approximately true for curved pipeline walls.

The third ultrasonic signal subsequently propagates through the gas in the pipeline and is eventually received by the second ultrasonic transducer 12 where it is detected. The detected time response of the ultrasonic transducer 12 may be sent to and displayed on a suitable display device and/or be stored for later retrieval and analysis by means of the signal controller mentioned above.

The third ultrasonic signal is a transmission signal and carries information about whether or not a (or, more precisely, at least one) defect is present in the inspected section of the pipeline wall 14. If there is a defect located in the path of a propagating Lamb wave, the transmitted Lamb wave amplitude drops and the receiving second transducer 12 records this drop in amplitude. Using the method according to the present invention, the signal quality and the signal-to-noise ratio can be improved by at least one order of magnitude compared to a known set-up using normal incidence.

In addition to the detection of cracks and other irregularities (i.e., to understand whether or not there is a defect), the detected third ultrasonic signal can also be used to further analyse certain characteristics of the detected defect 16 such as the orientation, location, dimension or nature of the defect 16 in the pipeline wall 14. The detected third ultrasonic signal may also be used to understand whether more than one defect (not shown) is present.

To further improve the signal-to-noise ratio and the overall detection accuracy, the first ultrasonic transducer 10 can be configured to additionally receive and detect a second ultrasonic signal returned from the surface of the pipeline wall 14, wherein the second ultrasonic signal is an echo signal generated by the at least one fundamental Lamb mode excited by the first ultrasonic signal and reflected from the defect 16 in the pipeline wall 14.

In an alternative embodiment, it is possible to dispense with the second ultrasonic transducer 12 (either physically altogether or at least as far as signal detection is concerned) and simply rely on the detection of the third pulse-echo signal received by the first ultrasonic transducer 10 to detect a flaw/defect 16 in the pipeline wall 14. Such an embodiment is shown in FIG. 1 above.

In another embodiment, both the first transducer 10 and the second transducer 12 are used as emitters and receivers of ultrasonic signals. To this end, the second ultrasonic transducer 12 is configured to emit a fourth ultrasonic signal towards the pipeline wall 14 at a negative finite angle of −α relative to the normal of the pipeline wall, wherein the fourth ultrasonic signal excites at least one fundamental Lamb mode in the pipeline wall. For instance, if the fourth signal is an ultrasonic pulse of length Δt₄ in the time-domain having a single frequency f₄, the angle α and the frequency f₄ are chosen such as to ensure that at least one fundamental Lamb mode is excited in the pipeline wall 14.

The first ultrasonic transducer 10 is then configured to receive and detect a fifth ultrasonic signal originating from the surface of the pipeline wall, wherein the fifth ultrasonic signal is generated by the at least one fundamental Lamb mode excited by the fourth ultrasonic signal and having propagated within the pipeline wall over the finite third distance d₃.

In a particularly preferred embodiment, the second ultrasonic transducer 12 is configured to receive and detect a sixth ultrasonic signal from the surface of the pipeline wall, wherein the sixth ultrasonic signal is an echo signal generated by the at least one fundamental Lamb mode excited by the fourth ultrasonic signal and reflected from the defect 16 in the pipeline wall 14.

In total, in this preferred embodiment, up to two transmission measurements (based on the detected second and fifth ultrasonic signals described above) and two pulse-echo measurements (based on the detected third and sixth ultrasonic signals described above), i.e., up to four measurements are possible and the combination of these measurements not only provides for an improved accuracy in detecting the presence of defects, but also makes it possible to gain additional insight into other characteristics of the defect(s) such as its orientation and location within the pipeline wall 14. Depending on the particular set-up and time constraints as well as, e.g., the material of the pipeline to be inspected or the expected nature of the defects, it may be advantageous to detect and process all or just a subset of these signals. For instance, it may be advantageous to detect and process just one or both of the pulse-echo signals only (i.e., the third and/or sixth ultrasonic signals), whereas in other scenarios it may be advantageous to use the transmission signal created by the first ultrasonic signal (i.e., the second signal) in combination with the pulse-echo signal created by the fourth ultrasonic signal (i.e., the sixth ultrasonic signal). Other combinations are possible.

The signal controller controlling the first and second ultrasonic transducers 10, 12 is preferably configured to cause an adjustable time delay between the first ultrasonic signal and the fourth ultrasonic signal being emitted to avoid interference between the two propagating Lamb modes in the pipeline wall 14 excited by the first and fourth ultrasonic signals. Depending on the specific excitation parameters and especially the frequencies f₁ and f₄, it may also be possible to emit the first and fourth ultrasonic signal essentially concurrently or at least with some temporal overlap to speed up the measurement process.

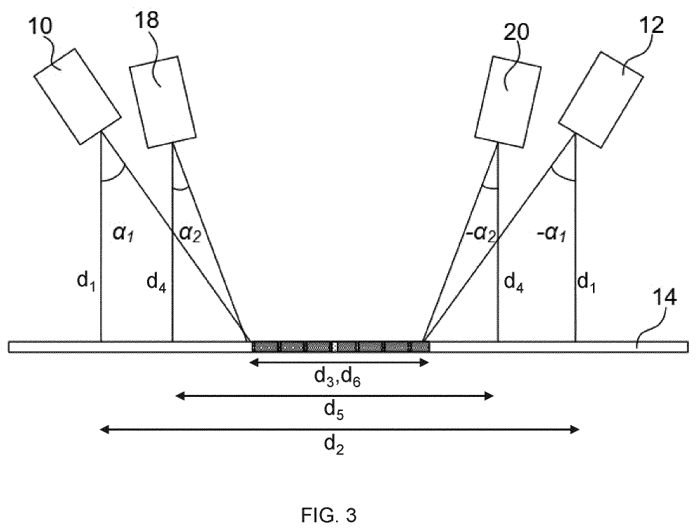

In a further embodiment shown in FIG. 3, a second pair of ultrasonic transducers 18, 20 is added comprising a third ultrasonic transducer 18 and a fourth ultrasonic transducer 20 configured to emit and receive signals at a different, second angle α₂ compared to the finite angle α of the first pair of transducers 10, 12. In other words, the first and second ultrasonic transducers 10, 12 span an angle of 2α between them, whereas the third and fourth ultrasonic transducers 18, 20 span an angle of 2α₂ between them. The second finite angle α₂ may be larger or smaller than the finite angle α.

As shown in FIG. 3, the first ultrasonic transducer 10 and the second ultrasonic transducer 12 are each arranged at a finite stand-off distance from the pipeline wall 14 in the direction of a normal of the pipeline wall 14 (i.e., in a radial direction in case of a circular cross-section). In addition, the first and second transducers 10, 12 are arranged at a distance from each other in a plane defined by the normal of the pipeline wall. Both distances are preferably defined by the distance between the pipeline wall 14 and the centre of the surface of each transducer creating the ultrasonic signal. Similarly, the third ultrasonic transducer 18 and the fourth ultrasonic transducer 20 are each arranged at a finite stand-off distance from the pipeline wall 14 in the direction of a normal of the pipeline wall 14 (i.e., in a radial direction in case of a circular cross-section), wherein the stand-off distance of the second pair of transducers 18, 20 may be different from or identical to the stand-off distance of the first pair of transducers 10, 12. In addition, as shown in FIG. 3, the third and fourth transducers 18, 20 are arranged at a distance from each other in a plane defined by the normal of the pipeline wall. The stand-off distances mentioned above are preferably defined by the distance between the pipeline wall 14 and the centre of the surface of each transducer creating/receiving ultrasonic signals. The second distances are preferably defined by the distance between the centres of the ‘active’ surfaces of the (preferably piezoelectric) transducers of each pair.

In this embodiment, all the transducers 10, 12, 18, 20 may be arranged on an inspection device such as a so-called pig comprising a signal controller having a processor and a memory (not shown) being operatively coupled with the transducers 10, 12, 18, 20 and configured to control each transducer 10, 12, 18, 20 to emit ultrasonic signals as well as to receive from each transducer 10, 12, 18, 20 signals which correspond to received ultrasonic signals. The inspection device may further comprise a power source to provide power to the ultrasonic transducers 10, 12, the signal controller as well as other components.

Preferably, single frequency pulses, each having an adjustable frequency and adjustable length Δt, are used to excite particular Lamb modes within the pipeline wall, wherein both transmission and/or echo signals are being picked up by the transducers 10, 12, 18, 20. For instance, when the first ultrasonic transducer is emitting a single frequency pulse, transmission response signals can be picked up by the second transducer 12 and the fourth transducer 20, whereas reflection/echo signals can be picked up by the first transducer 10 itself and the third transducer 18. As described above, the signal controller with which all the transducers 10, 12, 18, 20 are operatively coupled controls the transducers 10, 12, 18, 20 to ensure that the signals are emitted and received at appropriate times and that the received signals are being displayed, forwarded, and/or stored for further analysis.

Having a second pair of transducers 18, 20 being configured to emit/receive ultrasonic signals at a second, different angle α₂ means that additional insights can be obtained by emitting ultrasound signals (preferably each in the form of an adjustable single-frequency pulse of adjustable length Δt), from one, several or even all the transducers 10, 12, 18, 20, preferably in a staggered, time-delayed fashion so as to avoid interferences and overlap of signals, and receiving ultrasound response signals (either by transmission or reflection) by one, several or even all the transducers 10, 12, 18, 20.

By detecting the transmission and/or pulse-echo response signals by one, several or all the transducers, a tailored detection program can be run depending on the required inspection accuracy and speed. For instance, the first and third transducers 10, 18 may be controlled, by the signal controller, to emit single frequency pulses at appropriate frequencies, having desired lengths Δt as well as a suitable gap in the time domain between them so as to be able to clearly detect and identify the response signals pertaining to each pulse. Response signals may, in this particular example, be detected by all the transducer 10, 12, 18, 20 or, alternatively, just a subset of the transducers 10, 12, 18, 20 depending on the particular requirements and boundary conditions.

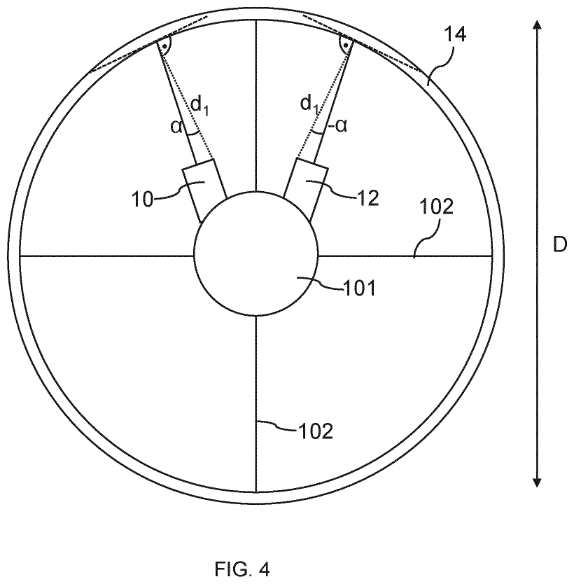

FIG. 4 shows an embodiment of a pipeline inspection device. The pipeline inspection device may be configured and/or adapted and/or adjusted for being inserted into a pipeline with a pipeline wall 14, in particular with a pre-known inner diameter D.

The pipeline inspection device comprises a support structure with mounting means 101 and at least one spacer 102. For example, exactly one spacer 102 or exactly two spacers 102 may be used. The spacer 102 may follow the shape of the pipeline, e.g. in a circular cross-section (e.g. a cylindrical shape). Alternatively, more than two spacers 102 may be used. The shape and/or size and/or position of the at least one spacer 102 is chosen such that an inner part of the pipeline inspection device, e.g. the mounting means 101, has a fixed spacing to the pipeline wall 14 when the pipeline inspection device is inserted into a pipeline (e.g. in operation of the pipeline inspection device).

The pipeline inspection device further comprises a mounting means 101. A first ultrasonic transducer 10 may be mounted to the mounting means 101. Optionally, a second ultrasonic transducer 12 (or even a third and/or fourth ultrasonic transducer, not shown in FIG. 4) may be mounted to the mounting means 101. The distance of the first ultrasonic transducer 10 and the second ultrasonic transducer 12 in FIG. 4 is shown exaggerated to enable a better understanding of the pipeline inspection device. However, in reality, the distance will be less pronounced and the pipeline wall may be approximated as a planar surface, as shown in FIGS. 1 to 3. A signal controller (not shown) may be operatively coupled with the first ultrasonic transducer 10 (and/or the further, optional ultrasonic transducers). The signal controller may be configured to control the first (and/or optional further) ultrasonic transducer 10 to emit a first ultrasonic signal (and/or optional further ultrasonic signals). The ultrasonic signal may be emitted through a beam exit of the ultrasonic transducer.

The first ultrasonic transducer 10 (and/or the optional further ultrasonic transducers) may be fixedly attached to the mounting means 101. The first (and/or optional further) ultrasonic transducer 10 may be mounted such that the beam exit has a fixed, pre-defined position with respect to a pipeline wall of a pipeline into which the pipeline inspection device is to be inserted. Therefore, a propagation axis of the emitted ultrasonic signal may have a fixed angle α, −α with the pipeline wall.

From to the arrangement of the mounting means 101 and the spacer 102 and the ultrasonic transducers 10, 12 mounted on the mounting means 101, it may be possible to determine the interaction of the components of the pipeline inspection device with the pipeline wall 14 without inserting the device into the pipeline, merely by examining the structure (e.g. geometry) of the mounting means 101 and the spacer 102.

The first ultrasonic transducer 10 may be mounted to the mounting means 101 such that, in operation of the pipeline inspection device, the first ultrasonic signal encloses a finite angle α with the normal of the pipeline wall 14. Further, the mounting means 101 and the at least one spacer 102 may be arranged and/or adjusted such that, in operation of the pipeline inspection device, the first ultrasonic transducer 10 has a pre-determined finite stand-off distance d₁ to a pipeline wall 14 of the pipeline. The stand-off distance d₁ may be measured along a surface normal of the pipeline wall 14, in particular the surface normal at the point of impact of the first ultrasonic signal on the pipeline wall 14.

Furthermore, the optional second ultrasonic transducer 12 may be mounted to the mounting means 102 such that, in operation of the pipeline inspection device, a third ultrasonic signal emitted by the second ultrasonic transducer 12 encloses a negative finite angle −α with the normal of the pipeline wall 14. The mounting means 101 and the at least one spacer 102 may be arranged and/or adjusted such that, in operation of the pipeline inspection device, the second ultrasonic transducer 10 has the finite stand-off distance d₁ to the pipeline wall 14.

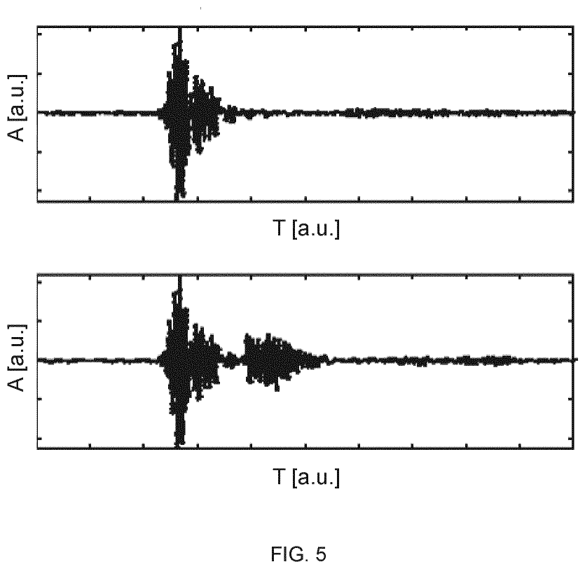

FIG. 5 shows an exemplary measurement signal as derived with a method and/or a pipeline inspection device as explained above. In particular, the upper and the lower part of FIG. 5 both show an amplitude A of an ultrasonic signal measured over a time-of-flight T. In the measurement, an ultrasonic transducer (e.g., comprising the first ultrasonic transducer 10) emits an ultrasonic signal (e.g., comprising the first ultrasonic signal). The ultrasonic signal impinges on the surface of the pipeline wall 14 at a finite angle α relative to the pipeline wall 14. A first part of the ultrasonic signal is reflected by the surface of the pipeline wall 14 and measured by the ultrasonic transducer (so-called surface echo). A second part of the ultrasonic signal (e.g., the first ultrasonic signal) may excite at least one fundamental Lamb mode in the pipeline wall 14. If a defect 16 is present in the propagation path of the Lamb mode in the pipeline wall 14, at least part of the Lamb mode signal is reflected by the defect 16 and propagates back to the ultrasonic transducer, where it is measured (so-called Lamb wave echo signal).

The upper part of FIG. 5 shows an exemplary ultrasonic signal measured by the ultrasonic transducer in the case where only a surface echo is measured and no defect is detected. The lower part of FIG. 5 shows an exemplary ultrasonic signal measured by the ultrasonic transducer when there is also a Lamb wave echo measured by the ultrasonic transducer. The Lamb wave echo can be clearly distinguished from the surface echo, both in time-of-flight as well as the signal shape. From the time-of-flight signal, it may be possible to determine that a defect 16 is present. In addition, the location of the defect 16 may be determined from the time delay of the Lamb wave echo compared to the surface echo. Furthermore, the amplitude of the Lamb wave echo may allow for determining the dimension (e.g., size), nature (e.g. type) and/or orientation of the defect 16. The pipeline inspection device may also comprise further ultrasonic transducers that may also detect the defect, but from a different perspective. By evaluating the respective signal from different ultrasonic transducers and combining the acquired information, the defect may be characterized in a very precise way. The Lamb wave echo in the lower part of FIG. 5 shows a high signal-to-noise ratio compared to the background signal.

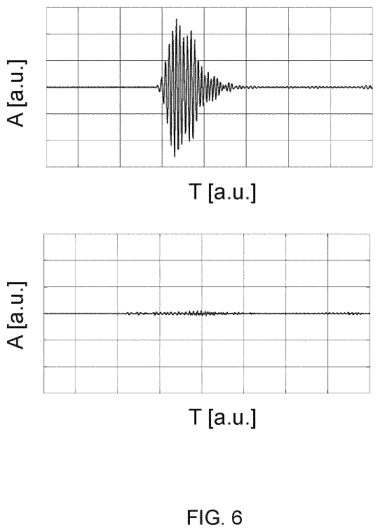

FIG. 6 shows exemplary measurement signals of an amplitude A of an ultrasonic signal measured over a time-of-flight T for a so-called pulse-catch method according to some embodiments described herein. The amplitude A and the time-of-flight T are depicted in arbitrary units (a.u.), but are scaled equally for the upper part of FIG. 6 and the lower part of FIG. 6. For both measurements, a first ultrasonic signal was emitted by a first ultrasonic transducer onto a solid and a Lamb wave was excited by the first ultrasonic signal. The Lamb wave propagates in the solid and at least a part of the Lamb wave is coupled out of the solid, e.g. as a third ultrasonic signal, and received by a second ultrasonic transducer. The upper part of FIG. 6 shows the measured third ultrasonic signal in the case of a finite angle of incidence of the first ultrasonic signal according to at least some embodiments described herein. The lower part of FIG. 6 shows the measured third ultrasonic signal in the case of an angle of incidence that is approximately zero or equal to zero.

As can be seen from FIG. 6, using a finite angle of incidence may result in a significantly higher signal-to-noise ratio than using a vanishing angle of incidence. The signal-to-noise ratio may be in the range of at least 45 or even at least 50 dB for a finite angle of incidence. In contrast, in the case of an angle of incidence that is approximately or exactly zero, the signal-to-noise ratio of the transmitted Lamb wave received in pitch-catch may be in the range of at most 10 dB. From such a small signal-to-noise ratio, it may be difficult, if possible at all, to determine the exact arrival time of a Lamb wave echo. By emitting the ultrasonic signal with a finite angle of incidence, the signal-to-noise ratio may be improved by a factor of at least 50 or even at least 100.

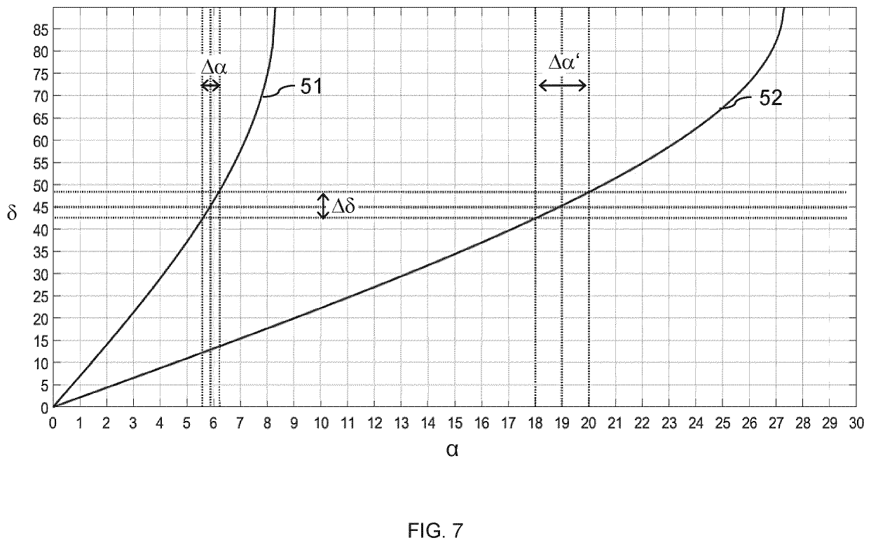

Further exemplary effects of the method and the device described herein are explained with reference to FIG. 7, which shows a calculated relationship between the angle of incidence α and the angle of intromission δ for a shear bulk wave being transmitted from a first material to a second, denser material at an interface. The angle of intromission δ may correspond to the shear bulk wave angle in the denser material (e.g., steel). The first curve 51 represents a first interface between pressurized methane gas (speed of sound 466 m/s) and steel (speed of sound 3230 m/s). The second curve 52 represents a second interface between water (speed of sound 1484 m/s) and steel (speed of sound (3230 m/s). For the first interface (first curve 51), the intromission angle δ strongly depends on the angle of incidence α. For the second interface (second curve 52), the dependency is less pronounced. For example, for a given variance Δδ of the intromission angle δ, the tolerance Δα of the angle of incidence α for methane may be only ±0.3°, while the tolerance Δα′ of the angle of incidence α for water may be ±1°. For transmission of shear bulk waves, the tolerance in a pressurized gas environment therefore is typically lower than for a liquid environment. The tolerance in a pressurized gas environment typically is too low for a practical implementation of an in-line inspection method based on the excitation of shear bulk waves.

In contrast to using shear bulk waves, the present invention relies on the creation of Lamb waves, in particular A0 and/or S0 Lamb wave modes. For these waves, the tolerance of the angle of incidence for a pressurized gas environment typically is approximately the same as for shear bulk waves with a liquid environment. For example, for the first interface and a given variance Δδ of the angle of intromission δ, the tolerance Δα for the first interface may be ±1° for a Lamb wave in the A0 and/or S0 mode, but significantly less for bulk shear waves. For the second interface, the tolerance Δα′ for the same variance Δδ may be ±1°. By using Lamb waves instead of shear bulk waves, the measurement in a pressurized gas environment therefore may be equally robust as in a liquid environment.
First ultrasonic transducer 10
Second ultrasonic transducer 12
Pipeline wall 14
Diameter D
Defect/crack 16
Finite angle α
Negative finite angle −α
Second finite angle α₂
Negative second finite angle −α₂
Stand-off distance d₁
Second distance d₂
Third distance d₃
Further stand-off distance d₄
Fifth distance d₅
Sixth distance d₆
Third ultrasonic transducer 18
Fourth ultrasonic transducer 20
Mounting means 101
Spacer 102
First curve 51
Second curve 52
Intromission angle δ
Variance of intromission angle Δδ
Tolerance of angle of incidence Δα, Δα′

1. A method for detecting a defect in a pipeline wall, comprising the steps of
arranging a first ultrasonic transducer inside a pipeline at a finite stand-off distance (d₁) from the pipeline wall;
emitting, by the first ultrasonic transducer, a first ultrasonic signal towards the pipeline wall at a finite angle (α) relative to a normal of the pipeline wall, wherein the first ultrasonic signal excites at least one fundamental Lamb mode in the pipeline wall; and
receiving, by the first ultrasonic transducer, a second ultrasonic signal from the surface of the pipeline wall, wherein the second ultrasonic signal is an echo signal generated by the at least one fundamental Lamb mode excited by the first ultrasonic signal and reflected from a defect in the pipeline wall.

2. The method according to claim 1, wherein the first ultrasonic signal is an ultrasonic pulse of length Δt₁ in the time-domain having a single frequency f₁.

3. The method according to claim 1, wherein the stand-off distance (d₁) is measured along the direction of the normal of the pipeline wall.

4. The method according to claim 1, further comprising the steps of:
arranging a second ultrasonic transducer inside the pipeline at a finite stand-off distance (d₁) from the pipeline wall, wherein the first ultrasonic transducer and the second ultrasonic transducer are arranged at a second distance (d₂) from each other;
receiving, by the second ultrasonic transducer, a third ultrasonic signal from the surface of the pipeline wall, wherein the third ultrasonic signal is generated by the at least one fundamental Lamb mode excited by the first ultrasonic signal and having propagated within the pipeline wall over a finite third distance (d₃).

5. The method according to claim 4, wherein the second distance (d₂) is measured in a plane defined by a normal of the pipeline wall.

6. The method according to claim 4, further comprising the steps of
emitting, by the second ultrasonic transducer, a fourth ultrasonic signal towards the pipeline wall at a negative finite angle (−α) relative to a normal of the pipeline wall, the negative finite angle having the same absolute value as the finite angle (α) but the reverse direction, wherein the fourth ultrasonic signal excites at least one fundamental Lamb mode in the pipeline wall; and at least one of:
(i) receiving, by the first ultrasonic transducer, a fifth ultrasonic signal from the surface of the pipeline wall, wherein the fifth ultrasonic signal is generated by the at least one fundamental Lamb mode excited by the fourth ultrasonic signal and having propagated within the pipeline wall over the finite third distance d₃ or
(ii) receiving, by the second ultrasonic transducer, a sixth ultrasonic signal from the surface of the pipeline wall, wherein the sixth ultrasonic signal is an echo signal generated by the at least one fundamental Lamb mode excited by the fourth ultrasonic signal and reflected from a defect in the pipeline wall.

7. The method according to claim 4, wherein the third distance (d₃) is equated by the equation: d₁−2*d₂*tan(α), with d₁ being the stand-off distance, d₂ being the second distance and a being the finite angle.

8. The method according to claim 4, further comprising the steps of
arranging a third ultrasonic transducer inside the pipeline;
emitting, by the third ultrasonic transducer, a further ultrasonic signal at a second finite angle (α₂) relative to a normal of the pipeline wall, the second finite angle (α₂) being different from the first finite angle (α), wherein the emitted further ultrasonic signal excites at least one fundamental Lamb mode in the pipeline wall; and
receiving, with the first ultrasonic transducer and/or if applicable the second ultrasonic transducer, a response ultrasonic signal from the surface of the pipeline wall, wherein the response ultrasonic signal is generated by the at least one fundamental Lamb mode excited by the further ultrasonic signal and having propagated within the pipeline wall over a finite distance.

9. The method according to claim 4, further comprising the steps of
arranging a third ultrasonic transducer and a fourth ultrasonic transducer inside the pipeline, each at a finite further stand-off distance (d₄) from the pipeline wall, wherein the third and fourth transducers are arranged at a finite fifth distance (d₅) from each other;
emitting, by the third ultrasonic transducer, a seventh ultrasonic signal towards the pipeline wall at a second finite angle α₂ relative to a normal of the pipeline wall, the second finite angle (α₂) being different from the first finite angle (α), wherein the seventh ultrasonic signal excites at least one fundamental Lamb mode in the pipeline wall; and
receiving, by the fourth ultrasonic transducer, an eighth ultrasonic signal from the surface of the pipeline wall, wherein the eighth ultrasonic signal is generated by the at least one fundamental Lamb mode excited by the seventh ultrasonic signal and having propagated within the pipeline wall over a finite sixth distance (d₆) or by the at least one fundamental Lamb mode excited by the first ultrasonic signal.

10. The method according to claim 1, wherein the ultrasonic signal received by the first ultrasonic transducer is further processed with a signal processing unit, wherein the signal processing unit decides whether or not a defect is present in the pipeline wall depending on the received ultrasonic signal.

11. A pipeline inspection device for being inserted into a pipeline, comprising
a first ultrasonic transducer;
a signal controller being operatively coupled with the first ultrasonic transducer and configured to control the first ultrasonic transducer to emit a first ultrasonic signal; and
a support structure comprising a mounting means and at least one spacer;
wherein the first ultrasonic transducer is mounted to the mounting means such that, in operation of the pipeline inspection device, the first ultrasonic signal encloses a finite angle (α) with a normal of the pipeline wall, and
wherein the mounting means and the at least one spacer are arranged and/or adjusted such that, in operation of the pipeline inspection device, the first ultrasonic transducer has a pre-determined finite stand-off distance (d₁) to a pipeline wall of the pipeline.

12. The pipeline inspection device according to claim 11, wherein the first ultrasonic transducer is configured to receive a second ultrasonic signal.

13. The pipeline inspection device according to claim 11, wherein the finite angle (α), the stand-off distance (d₁) and the first ultrasonic signal are chosen such that, in operation of the pipeline inspection device, at least one fundamental Lamb mode is excited in the pipeline wall by the first ultrasonic signal.

14. The pipeline inspection device according to claim 11, further comprising:
a second ultrasonic transducer,
wherein the second ultrasonic transducer is configured to receive a third ultrasonic signal;
wherein the first ultrasonic transducer and the second ultrasonic transducer are arranged such that, in operation of the pipeline inspection device, the first ultrasonic transducer and the second ultrasonic transducer are arranged at a second distance (d₂) from each other;
wherein the mounting means and the at least one spacer are arranged and/or adjusted such that, in operation of the pipeline inspection device, the second ultrasonic transducer has the pre-determined finite stand-off distance (d₁) to the pipeline wall of the pipeline.

15. The pipeline inspection device according to claim 14,
wherein the signal controller is further coupled with the second ultrasonic transducer and configured to control the second ultrasonic transducer to emit a fourth ultrasonic signal,
wherein the second ultrasonic transducer is mounted to the mounting means such that, in operation of the pipeline inspection device, the fourth ultrasonic signal encloses a negative finite angle (−α) with a normal of the pipeline wall, the negative finite angle having the same absolute value as the finite angle (α) but the reverse direction.

16. The pipeline inspection device according to claim 14, further comprising
a third ultrasonic transducer and/or a fourth ultrasonic transducer being operatively coupled with the signal controller, wherein the signal controller is configured to control each ultrasonic transducer to emit and/or receive ultrasonic signals.

17. A pipeline inspection device adapted to carry out the method according to claim 1.

18. The pipeline inspection device according to claim 11, further comprising a signal processing unit that is operatively coupled to the first ultrasonic transducer and that is adapted to further process an ultrasonic signal from the first ultrasonic transducer.
